(19) United States
(12) Patent Application Publication
(10) Pub. No.: US 2022/0351551 A1
(43) Pub. Date: Nov. 3, 2022

(54) Device, System and Method for Electronic Toll Tax Payment

(71) Applicant: James Cavanagh, Centreville, MD (US)

(72) Inventor: James Cavanagh, Centreville, MD (US)

(21) Appl. No.: 17/706,793

(22) Filed: Mar. 29, 2022

Related U.S. Application Data
(60) Provisional application No. 63/180,781, filed on Apr. 28, 2021.

(51) Int. Cl. G07B 15/06; G06Q 20/20; G06K 7/10

(52) U.S. Cl. CPC G07B 15/063; G06Q 20/207; G06K 7/10445

(57) ABSTRACT

The present invention relates to a novel wireless toll payment transponder device that can be embedded or retrofitted to a vehicle. More specifically, the toll payment device is used for paying toll tax at toll booths without blocking the field of vision of the driver of the vehicle. The device provides efficient movement of the vehicles on highways and through toll booths, without the fear of an accident. The device includes a transponder for wireless communication and storage of transponder information. The transponder further includes a location detector for detecting the location of the vehicle to which the device is mounted. The transponder device enables payment of toll taxes while providing location information simultaneously.

### CROSS-REFERENCE TO RELATED APPLICATION

The present application claims priority to, and the benefit of, U.S. Provisional Application No. 63/180,781, which was filed on Apr. 28, 2021 and is incorporated herein by reference in its entirety.

### FIELD OF THE INVENTION

The present invention relates generally to the field of a radio frequency identification (RFID) technology-based electronic chip transponder device. More specifically, the present invention relates to an RFID-based toll tax transponder device, comprising an electronic chip transponder, designed to electronically pay toll payments while the vehicle is in motion, and a location detector that monitors the real-time location of the vehicle. The RFID-based electronic device can be embedded and/or retrofitted to a vehicle license plate. The RFID-based electronic device can be made of tamper-proof material, which ensures the device remains intact and prohibits any damage to the electronic circuitry. Accordingly, the present disclosure makes specific reference thereto. Nonetheless, it is to be appreciated that aspects of the present invention are also equally applicable to other applications, devices and methods of manufacture.

### BACKGROUND OF THE INVENTION

By way of background, road pricing or tolling can be defined as the practice of tax collection from motorists who use roadway facilities (U.S. Department of Transportation Federal Highway Administration, n.d.). The collected toll taxes are often used for road/transportation expansion, operational and maintenance purposes. Traditionally, toll taxes were manually collected via coin, cash or card transactions at dedicated toll booths. The process included placing some change in a basket, which tabulates/adds the coins and opens a gate to allow a driver therethrough. However, this system was often criticized as motorists/drivers were required to stop to pay the toll tax. The stopping of vehicles results in traffic congestion at the toll booths during peak hours and has been proven to result in fuel inefficiency. To effectively address the complications from manual toll collection, electronic toll collection (ETC) emerged as the key solution to enable a fast, efficient and cashless payment option for the collection of toll tax.

In recent years, the adoption of ETC systems has increased. The ETC systems allow vehicle users to pay tolls using a toll road utilizing a radio frequency tag. The radio frequency transponder tag, such as a toll pass or toll tag, can be mounted on the windshield or visor of a vehicle for paying the toll tax. Further, a radio frequency transmitter or antenna activates and intercepts the radio frequency transponder tag mounted in the vehicle for identifying the user account. When the vehicle with a mounted radio frequency transponder tag passes through a toll collection location equipped to communicate with the transponder, the collection of data from the device mounted on the vehicle enables the charging of the user's ETC account for the amount of the toll. Generally, the transponders need to adhere to the windshield of the vehicle, so that the radio frequency transmitter or antenna mounted at the toll booths can read the transponders and deduct the toll tax.

However, in many states attaching the transponder to the windshield or visor can be illegal. Also, it often creates a blind spot, can distract the driver and may cause an accident. Sometimes, drivers try to hold the transponder up as they pass through the tollbooth, which can also cause accidents.

In addition, the conventional tags are used for only paying toll tax and do not offer additional functionality. A vehicle owner may have to install a GPS unit for tracking live (i.e. real-time) location of the vehicle. It is desirable to have the transponder include additional functionalities enabling central tracking of the vehicle in addition to paying toll tax.

In some cases, drivers can create a nuisance near the toll booth and the tag may not be captured by surveillance cameras located at the toll booth. It would be desirable to record the registered vehicle number using the toll tax or vehicle pass transponder, so that the authorities can take proper action.

Therefore, there exists a long felt need in the art for an improved toll tax transponder that is mounted in a convenient position on the vehicle without obstructing the view of the driver. There is also a long felt need in the art for an improved toll tax transponder that ensures the transponder is away from the field of vision of the driver, yet performs its function. Additionally, there is a long felt need in the art for an improved toll tax transponder that can be fixed at a mounted location and left untouched. Moreover, there is a long felt need in the art for an improved toll tax transponder that helps in monitoring the real-time location of the vehicle, and therefore prevents the vehicle from being stolen. Further, there is a long felt need in the art for an improved toll tax transponder that links with the vehicle registration information for additional security. Finally, there is a long felt need in the art for an improved toll tax transponder that is linked to a vehicle, activated at all times and allows easy payment of toll taxes.

The subject matter disclosed and claimed herein, in one embodiment thereof, comprises a RFID-based toll payment device configured to be embedded in a license plate of the vehicle. The device includes a transponder and a location detector. The transponder is linked to a prepaid account of the driver, and a particular amount is deducted from the prepaid account as soon as the vehicle crosses the toll booth affixed with RFID readers and the location detector is configured to monitor the real-time location of the vehicle.

In this manner, the novel RFID toll payment transponder of the present invention accomplishes all of the foregoing objectives, and provides a relatively safe, easy and convenient solution to automatically pay toll taxes at ETC booths. The RFID toll payment transponder of the present invention is also secure, as it allows a vehicle to be tracked for the purpose of amber alerts, silver alerts, missing vehicles or vehicle theft. The RFID-based toll payment device of the present invention can be linked with the vehicle registration for additional security. The transponder can be imbedded or retrofitted to vehicle license plates for paying highway tolls, and eliminates the need to attach a transponder to a windshield or visor, which can create blind spots and may be illegal.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a RFID toll payment transponder device. The RFID toll payment transponder device is used for electronically paying toll tax payments. The transponder device further comprises: a front surface and a rear surface; the front surface having a transponder in the form of an electronic chip and a location detector; an adhesive layer at the rear surface; the transponder storing device identification number and is configured to establish an RFID communication; and, the location detection detects current location of the device. The RFID toll payment transponder device can be embedded or retrofitted to a license plate of the vehicle. Further, the transponder can be linked to a prepaid account of a user and a particular amount can be electronically deducted from the prepaid account when the vehicle on which the transponder device is mounted crosses the toll booth affixed with RFID readers.

In a further embodiment of the present invention, the transponder of the RFID-based toll payment device disclosed herein is linked to a user account that holds the electronic money in lieu of cash thus helping the vehicle users to reduce fuel costs and cut the average waiting time.

In a further embodiment of the present invention, the location detector of the RFID-based transponder device enables easy tracking of the vehicle and further ensures the safety of the vehicle. In a further embodiment of the present invention, the transponder device is linked to a vehicle registration number enabling unique correlation of a vehicle with the transponder device, and makes the transponder device non-transferrable. In yet a further embodiment of the present invention, the transponder device is embedded or retrofitted to a front and/or a rear license plate eliminating the need to attach the RFID transponder device to a windshield or visor, thereby eliminating blind spots.

In yet another embodiment of the present invention, a method for automatically deducting toll tax amount is described. The method includes: purchasing an RFID toll tax payment transponder device; adding amounts to an account associated with the transponder device; embedding or retrofitting the purchased transponder device to either a front or a rear license plate of a vehicle; receiving by the transponder device RFID signals from an RFID recorder located at a tollbooth; transmitting by the transponder device unique transponder identity to the RFID recorder; checking available balance in the account associated with the transponder device; and, electronically deducting the toll tax amount from the account balance.

In yet another embodiment, the method includes real-time location tracking of the vehicle to which the transponder device is mounted using a location detector of the RFID toll tax payment transponder device. In yet another embodiment of the present invention, user information, account balance, vehicle registration number and the identity of the transponder device are stored in one or more central or distributed databases.

In yet another embodiment of the present invention, an electronic toll system is disclosed. The system includes a wireless toll communication transponder, a wireless antenna device, a data center having a controller, the wireless toll communication transponder can be attached to a license plate of a vehicle and transmits transponder information to the wireless antenna device, the wireless antenna device transmits the transponder information to the data center for deducting the toll tax amount and the wireless antenna device, upon successful deduction of amount from an account associated with the transponder, can allow the vehicle to pass through the toll.

The advantage of the RFID-based toll payment transponder device and system of the present invention is that they allow prevention of accidents, because the transponder is not attached to the windshield and drivers do not fumble around with the transponder device trying to apply it to the windshield. Further, the RFID-based toll payment device is linked with the vehicle registration number for providing additional security. Further, the RFID-based toll payment device can be activated at any time or activated all the time, thus locating the vehicle easily if lost or stolen.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a wireless toll payment transponder device of the present invention in accordance with the disclosed architecture;

FIG. 2 illustrates one potential embodiment of an electronic toll collection system 200 using the wireless toll payment transponder device 100 of the present invention in accordance with the disclosed architecture;

FIG. 3 illustrates a block diagram showing a working principle of the toll payment transponder device of the present invention in accordance with the disclosed architecture;

FIG. 4 illustrates a flow diagram showing an exemplary method 400 of deducting the toll tax from the toll payment transponder device 100 of the present invention in accordance with the disclosed architecture;

FIG. 5 illustrates a flow diagram 500 showing steps of checking a balance before deducting the toll payment in accordance with the disclosed architecture; and

FIG. 6 illustrates an exemplary flow diagram 600 for payment processing of the transponder device of the present invention in accordance with the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there a long felt need in the art for an improved toll tax transponder that is mounted in a convenient position on the vehicle, without obstructing a view of the driver. There is also a long felt need in the art for an improved toll tax transponder that ensures the transponder is out of the way from the field of vision of the driver yet performs its function. Additionally, there is a long felt need in the art for an improved toll tax transponder that can be fixed at a location or position and left untouched. Moreover, there is a long felt need in the art for an improved toll tax transponder that helps in monitoring the real-time location of the vehicle, and therefore prevents the vehicle from being stolen. Further, there is a long felt need in the art for an improved toll tax transponder that links with vehicle registration information for additional security. Finally, there is a long felt need in the art for an improved toll tax transponder that is linked to a vehicle, activated anytime or all the time and allows easy payment of toll taxes.

The present invention, in one exemplary embodiment, includes an RFID toll payment transponder device. The RFID toll payment transponder device can be used for electronically paying toll tax payments. The transponder device further comprises: a front surface and a rear surface; the front surface having a transponder in the form of an electronic chip and a location detector; an adhesive layer at the rear surface; the transponder storing device identification number and is configured to establish an RFID communication; and, the location detection detects current, or real-time, location of the device. The RFID toll payment transponder device can be embedded or retrofitted to a license plate of the vehicle. Further, the transponder can be linked to a prepaid account of a user and a particular amount can be electronically deducted from the prepaid account when the vehicle on which the transponder device is mounted crosses (i.e. passes through) a toll booth equipped with RFID readers.

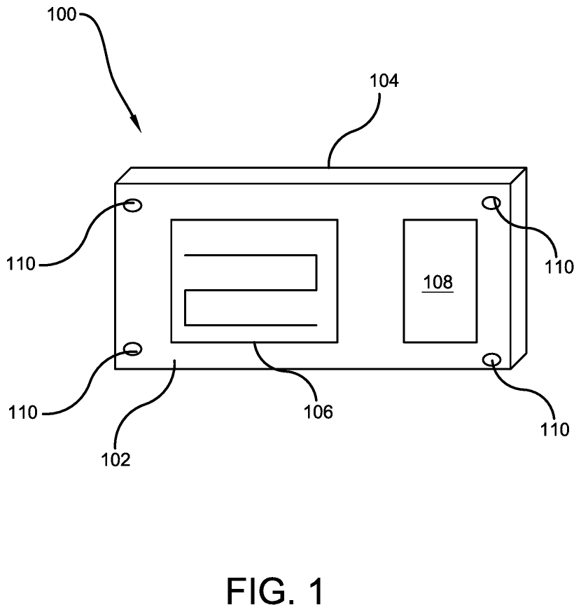

Referring initially to the drawings, FIG. 1 illustrates a perspective view of one potential embodiment of a wireless toll payment transponder device 100 of the present invention in accordance with the disclosed architecture. The wireless toll payment transponder 100, also referred to as “Car Tag EZ Pass”, is in the form of an integrated circuit and is designed to electronically pay the toll tax at a toll booth of an electronic toll-collection system using radio frequency identification (RFID) technology. The wireless toll payment device 100 can be mounted to a license plate of a vehicle and thereby does not obstruct the view of a driver. The Car Tag EZ Pass 100 enables a driver of the vehicle to pay the toll tax directly from an associated payment account without stopping his vehicle. In one potential embodiment of the present invention, the transponder 100 can be embedded or retrofitted onto the license plate of the vehicle. In one arrangement, the transponder 100 can be pasted onto the license plate of the vehicle using an adhesive backing 104. Separate transponders 100 can be adhered to the front license plate, as well as rear license plate, for overcoming drawbacks of the prior developed toll payment devices and/or cards.

The wireless toll payment device 100 is in the form of an electronic chip and includes a front surface 102 and a rear surface 104. The toll payment device 100 can be of different shapes and sizes, such as, but not limited to: a cuboid, cube, cylinder, a hexagon, a square, a rectangle, and so forth. Embodiments of the present invention are intended to include or otherwise cover any of the shapes and the sizes for the toll payment transponder 100 including known, related art and/or later developed technologies.

The front surface 102 of the toll payment transponder 100 includes a transponder 106, and a location detector 108. The transponder 106 can be an electronic circuit that stores the necessary information about the vehicle and also a transponder identifier. The vehicle information can include, but not be limited to, a vehicle registration number, a vehicle class, an account balance, et. al. The vehicle information can be stored in the transponder 106. The transponder device 100 being linked to a vehicle registration number allows unique correlation of the vehicle with the transponder device 100 and makes the transponder device non-transferrable, thus, eliminating use of the transponder device 100 for another vehicle.

The transponder 106 includes RFID communication capabilities enabling the toll payment transponder device 100 to communicate to an electronic reader/antenna located at the toll booth. Embodiments of the present invention are intended to include or otherwise cover any type of vehicle information. Further, the transponder 106 can have a unique identification number that can be used to read or communicate all the vehicle information.

The transponder device 100 includes a location detector 108 configured to continuously transmit a real-time geographical location of the vehicle on which the payment tag 100 is mounted. The geographical location of the vehicle can be tracked by a user device or a server. The location information can be useful if the vehicle 210 is stolen or missing or during an amber or silver alert. According to embodiments of the present invention, the location detector 108 can be, but is not limited to, a geolocation sensor, a Global Positioning System (GPS) module and so forth. Embodiments of the present invention are intended to include or otherwise cover any type of the location detector 108 including known, related art and/or later-developed technologies that can be capable of detecting the geographical location of the vehicle. The location detector 108 can further enable an easy scan of a vehicle location in case of an amber or silver alert. In another embodiment, the location detector 108 can help the user to search the vehicle location using the user device in case the vehicle is stolen or lost.

It should be appreciated that a user can submit a request to establish an ETC account with a respective roadway management authority. The management authority then issues the novel toll payment transponder device 100 that a user can mount, for example, on the license plate of the vehicle. Also, the novel toll payment transponder device 100 can be pre-installed and activated with a new vehicle.

The transponder device 100 can also be mounted to the license plate of the vehicle using mounting screws 110 if adhesive backing 104 is not used as per the preferences of the user. The device 100 can also be used as a hands free device and/or used in instances of an Amber or Silver alert.

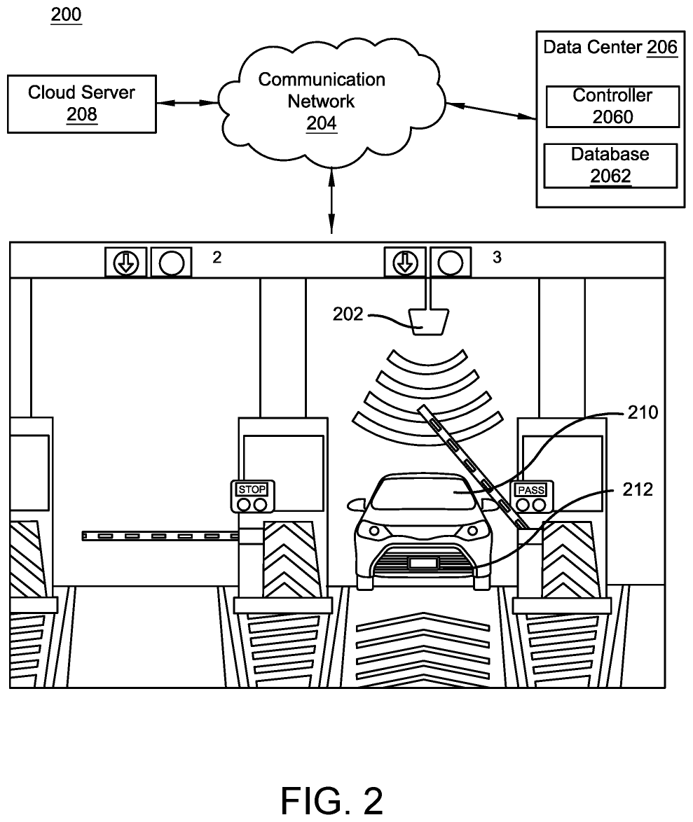

FIG. 2 illustrates one potential embodiment of an electronic toll collection system 200 using the wireless toll payment transponder device 100 of the present invention in accordance with the disclosed architecture. The electronic toll collection system 200 includes a RFID reader/antenna 202, a data center 206 and a cloud server 208. Further, the novel toll payment transponder device 100, the RFID recorder 202, the data center 206 and the cloud server 208 are connected through a communication network 204.

The communication network 204 can include a data network such as, but not limited to, an Internet, a Local Area Network (LAN), a Wide Area Network (WAN), a Metropolitan Area Network (MAN) and so forth. In some embodiments of the present invention, the communication network 204 can include a wireless network such as, but not limited to, a cellular network. The wireless network can employ various technologies including an Enhanced Data Rates for Global Evolution (EDGE), a General Packet Radio Service (GPRS), and so forth. In some embodiments of the present invention, the communication network 110 can include or otherwise cover networks or sub-networks, each of which can include, for example, a wired or a wireless data pathway. Embodiments of the present invention are intended to include or otherwise cover any type of the communication mediums, including known, related art and/or later developed technologies.

The novel toll payment device 100 can be mounted to license plate 212 of the vehicle 210 and is configured to electronically pay the toll tax at a particular toll booth of the ETC system 100 using radio frequency identification (RFID) technology. The mounting of the transponder device 100 to the license plate 212 eliminates the need to attach a transponder to a windshield or visor, eliminating creation of visual blind spots for the driver. The automatic payment of the toll tax at the toll booth of the ETC system 200 enables a quick flow of traffic. The toll payment device 100 enables the driver of the vehicle 210 to pay the toll tax without stopping the vehicle and paying the amount in cash. RFID recorder/transmitter/antenna 202 is configured to intercept and read information from the toll payment device 100. The RFID recorder 202 can use ultra-high frequency (UHF) that ranges from 860 megahertz (MHz) to 960 MHz. The RFID recorder 202 can be installed at a height above the toll booth. The RFID recorder 202 continuously broadcasts ultra-high radio frequency signals or pulses and received by the toll payment device 100. These pulses are then returned from the toll payment device 100 and are received by the RFID recorder 202. The reflected pulses from the toll payment device 100 contain information regarding the user accounts along with the unique identification number. The information can include, but not be limited to, vehicle registration number, vehicle class and account balance. Embodiments of the present invention are intended to include or otherwise cover any such type of information regarding the user account. Further, the RFID recorder 202 transmits the received information to the data center 206 through the communication network 204.

The data center 206 is configured to receive, store, process and transmit the data related to the ETC system 100. The data center 106 can further include a controller 2060 for processing data received from the RFID reader 104 to generate an output and perform other operations such as deducting balance from the ETC account of the user. The data center 206 includes the central repository of all the transponder devices 100 issued to the users and can be a centralized or distributed data center. The controller 2060 can be, but is not limited to, a Programmable Logic Control unit (PLC), a microcontroller, a microprocessor, a computing device, a development board and so forth. Embodiments of the present invention are intended to include or otherwise cover any type of the controller 2060 including known, related art, and/or later developed technologies that can be capable of processing the received data. In an exemplary scenario, the controller 2060 encrypts the contents of the received pulse from the RFID recorder 202 and identifies the prepaid account from which the cost of the toll should be deducted based on the unique identification number of the toll payment device 100.

The data center 206 also includes one or more databases 2062. The databases 2062 store and retrieve the data associated with the ETC system 100. More specifically, the databases 2062 store user information, registered vehicle number along with the transponder device identification, payment information and the like. Real time location information of the vehicle 210 to which the transponder device 100 is mounted can also be stored in the databases 2062. According to embodiments of the present invention, the databases 2062 can be, but not limited to, a centralized database, a distributed database, a personal database, an end-user database, a commercial database, a Structured Query Language (SQL) database, a non-SQL database, an operational database, a relational database, a cloud database, an object-oriented database, a graph database, and so forth. Embodiments of the present invention are intended to include or otherwise cover any type of the database 2062 including known, related art, and/or later developed technologies that can be capable of the data storage and retrieval.

The ETC system 100 can further comprise a cloud server 208 for storing data associated with the ETC system 100. The cloud server 208 can be periodically updated from the database 2062 through the communication network 204. In one potential embodiment of the present invention, the cloud server 108 can be, but not limited to, an AWS (Amazon Web Services) cloud, a Google doc, a Drive, and so forth. Embodiments of the present invention are intended to include or otherwise cover any type of the cloud server 208, including known, related art, and/or later developed technologies.

In operation, when the RFID reader 202 reads the information of the transponder device 100, the received information is stored and compared in both the data center 206 and the cloud server 208. When a user purchases the transponder device 100, the information of the user, balance information and the registered vehicle number can be stored in the ETC system 100. Both the data center 206 and the cloud server 208 are configured to store information of all the transponder devices 100 issued to the users.

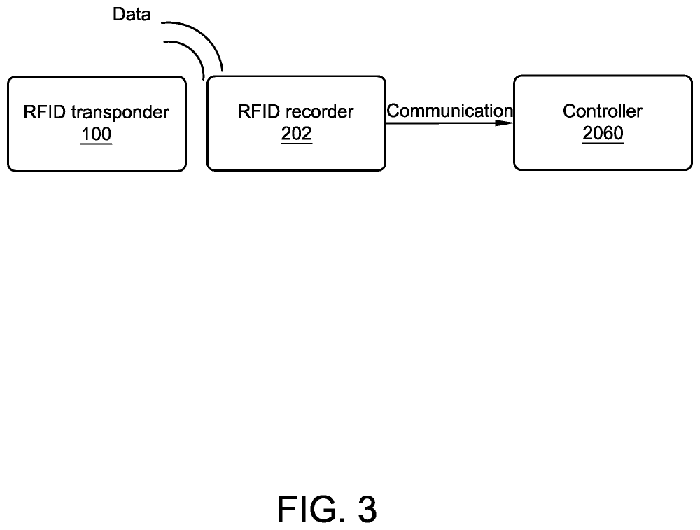

FIG. 3 illustrates a block diagram showing a working principle of the toll payment transponder device of the present invention in accordance with the disclosed architecture. In the ETC system 100, whenever a vehicle arrives in a toll plaza, ultra-high frequency RFID recorder/antenna 202 transmits signals to the transponder device 100 and activates the transponder. The transponder device 100 returns information to the RFID recorder/antenna 202. The data received by the RFID recorder/antenna 202 is transmitted to the controller 2060. In some cases, a local host computer (not shown) of the toll booth connected to the data center receives the data and processes the data. The controller 2060 then checks the information of the account consumer/driver and if the account has more credit than the required toll tax amount. The toll tax can be deducted on the basis of vehicle class, journey entry and exit point, journey duration and so forth. A transaction message can also be sent to the consumer/driver indicating the tax amount is paid and the remaining balance of the account. The controller 2060 stores all information of transaction in the databases, including the location of the toll plaza, date, time, and total amount payment of tax. If the credit of the account is lower than the tax amount, then the system generates an indication for a low balance.

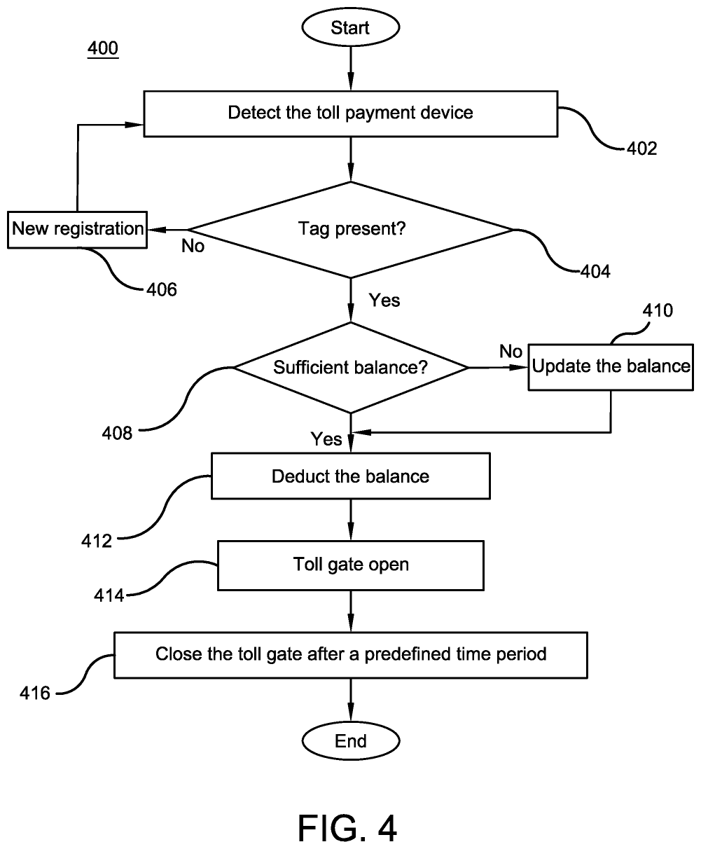

FIG. 4 illustrates a flow diagram showing an exemplary method 400 of deducting the toll tax from the toll payment transponder device 100 of the present invention in accordance with the disclosed architecture. Initially, at step 402, the ETC system detects the toll payment transponder device using RFID transponder. The transponder device can be attached to the license plate of the vehicle. At step 404, it is determined if the transponder tag device is detected or not. If the toll payment device is not detected by the ETC system then the method 400 can proceed to step 406, otherwise the method 300 can proceed to step 408. At step 406, the driver may need to purchase a new toll payment transponder device. To purchase the toll payment device, an individual can provide bank details and vehicle details, and based on the provided details, a unique identification number of the toll payment device can be linked with the vehicle details. All information of bank account, and particulars of an associated vehicle, are stored in the toll payment transponder device.

At step 408, the balance in the account of the user linked with the toll payment device is checked, and if there is sufficient balance available in the account then the method 400 can proceed to step 412, otherwise the method 400 may proceed to step 410. At step 410, the user can update the balance in the account using an online method. At step 412, the ETC system deducts the toll tax as per the type of vehicle. The toll tax can be different for different types of vehicles, such as, cars, vans, trucks, motorcycles, etc. At step 414, the toll gates are opened enabling the vehicle to pass therethrough. Finally, at step 416, the toll gate is closed after a predefined period. The period can be, but not limited to, 30 seconds, 1 minute, and so forth. In one potential embodiment of the present invention, the steps 408, 410, and 412 can be performed in the background, and in real-time, to prohibit any delay or wait time at the toll booth.

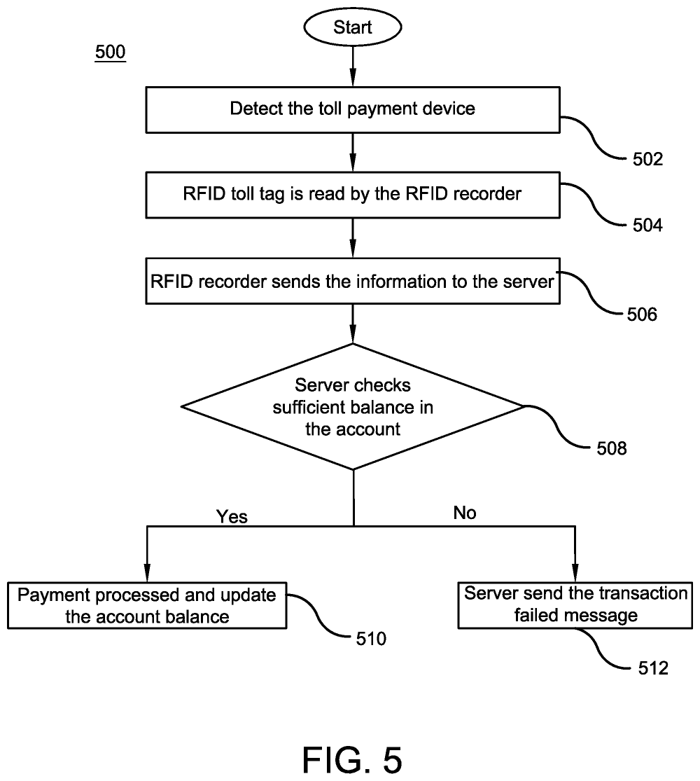

FIG. 5 illustrates a flow diagram 500 showing steps of checking the balance before deduction in accordance with the disclosed architecture. Initially at step 502, the toll payment transponder device on the vehicle is detected by the RFID reader placed at the tollbooth. At step 504, the RFID transponder tag is read by the RFID reader. The RFID recorder can be installed inside the road at the toll booth, in another embodiment of the present invention. At step 506, the RFID recorder transmits the received information to the server. The server can be a local server and/or a cloud server in addition to sending to a data center. The server can be configured to check for fund balance in the user's account. At step 508, if the balance is available in the user's account, then the process can proceed to step 510, otherwise the process can proceed to step 512, in case of unavailability of sufficient balance in user's account. At step 510, the payment is processed by deducting the toll tax from the user's account. The toll tax can be deducted, for example, on the basis of vehicle type and length of trip. The toll tax can be less in case of multiple trips within twenty-four hours. Further, the account balance can be updated on successful transaction of the toll tax. At 512, a transaction failed message can be transmitted to the user requesting the user to add money into the account.

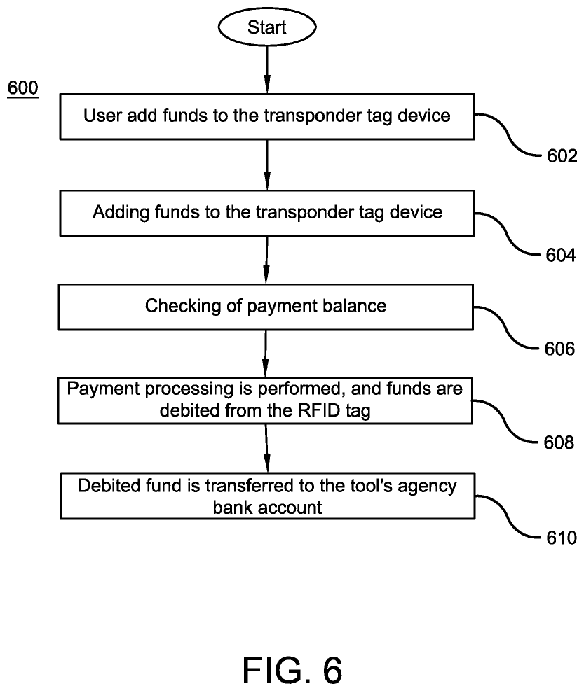

FIG. 6 illustrates an exemplary flow diagram 600 for payment processing of the transponder device of the present invention in accordance with the present invention. Initially at step 602, a user adds funds to the toll payment transponder device 102 using an online means as known in the state of the art. At step 604, the payment processing is performed, and funds are added to the toll payment transponder device and associated user account. At step 606, the balance in the account associated with the transponder device is checked. At step 608, payment processing is performed, and toll tax amounts can be debited from the user account. At step 610, the toll tax is debited from user's account and is transferred to the toll's agency bank account.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wireless toll payment transponder device”, “Car Tag EZ Pass”, “wireless toll payment device”, “transponder device”, and “novel toll payment transponder device” are interchangeable and refer to the wireless toll payment transponder device 100 of the present invention.

Notwithstanding the forgoing, the wireless toll payment transponder device 100 of the present invention can be of any suitable size and configuration as is known in the art without affecting the overall concept of the invention, provided that it accomplishes the above-stated objectives. One of ordinary skill in the art will appreciate that the size, configuration, and material of the wireless toll payment transponder device 100 as shown in the FIGS. are for illustrative purposes only, and that many other sizes and shapes of the toll payment transponder device 100 are well within the scope of the present disclosure. Although the dimensions of the wireless toll payment transponder device 100 are important design parameters for user convenience, the wireless toll payment transponder device 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wireless toll payment transponder device comprising:
a toll payment transponder device including an electronic circuit having vehicle information and transponder identifier information, wherein said vehicle information comprises information selected from the group consisting of a vehicle registration number, a vehicle class, and an account balance; and
a location detector configured to continuously transmit a real-time geographical location of a vehicle on which said transponder device is mounted, wherein said location detector is selected from the group consisting of a geolocation sensor and a Global Positioning System (GPS) module, and further wherein said geographical location of said vehicle is tracked real-time by a user device.

2. The wireless toll payment transponder device of claim 1, wherein at least one transponder device linked to at least one particular vehicle registration number for correlating said at least one transponder to said at least one particular vehicle registration.

3. The wireless toll payment transponder device of claim 2, wherein said at least one transponder includes a unique identification number.

4. The wireless toll payment transponder device of claim 3, wherein said user device is a server.

5. The wireless toll payment transponder device of claim 4, wherein said transponder includes an RFID communicator for communicating to an electronic reader at a toll booth.

6. A method for automatically deducting toll taxes from a user account, the method comprising the steps of:
purchasing an RFID toll tax payment transponder device;
adding amounts to said user account associated with said transponder device;
mounting said transponder device to an exterior of a vehicle;
receiving by said transponder device RFID signals from a RFID recorder located at a tollbooth;
transmitting by said transponder device a unique transponder identity to said RFID recorder;
checking an available balance in said user account associated with said transponder device; and
electronically deducting a toll tax amount from said user account.

7. The method of claim 6, wherein said mounting includes affixing said transponder device to a license plate of said vehicle.

8. The method of claim 7, wherein said signals activates said transponder.

9. The method of claim 8, wherein said toll tax amount is based on a criteria selected from the group consisting of a vehicle class, a journey entry point, a journey exit point and a journey duration.

10. The method of claim 9 further comprising messaging a user of said transponder device said toll tax amount paid.

11. The method of claim 10, further comprising messaging the user a remaining balance of said user account.

12. A method for automatically deducting toll taxes from a user account using an electronic toll collection system, the method comprising the steps of:
purchasing a toll tax payment transponder device;
adding funds to an account associated with said transponder device using said electronic toll collection system;
mounting said transponder device to a vehicle;
detecting said transponder device by said electronic toll collection system;
receiving by said transponder device signals from a recorder located at a tollbooth;
transmitting by said transponder device a unique transponder identity to said recorder; and
checking an available balance in said account associated with said transponder device, wherein said electronic toll collection system electronically deducts a toll tax amount from said account balance.

13. The method of claim 12, wherein said purchasing said toll tax payment transponder device includes providing bank details of said account and vehicle details of said vehicle.

14. The method of claim 12 further comprising a step of opening a toll gate to allow said vehicle to pass therethrough.

15. The method of claim 14 further comprising a step of closing said toll gate after said vehicle passes therethrough.

16. The method of claim 12, wherein the deducting of said toll tax amount is real-time.

17. The method of claim 12, wherein said toll tax amount is based on a criteria selected from the group consisting of a type of vehicle, a journey entry point, a journey exit point and a journey duration.

18. The method of claim 17 further comprising a step of messaging a user of said transponder device said toll tax amount paid.

19. The method of claim 18, further comprising messaging the user a remaining balance of said user account.

20. The method of claim 19, further comprising adding additional funds to said user account.
